(19) United States
(12) Patent Application Publication
(10) Pub. No.: US 2026/0273596 A1
(43) Pub. Date: Sep. 17, 2026

(54) DUST COLLECTION APPARATUS, RESIN MOLDING APPARATUS, AND METHOD FOR MANUFACTURING RESIN MOLDED PRODUCT

(71) Applicant: TOWA CORPORATION, Kyoto-shi, Kyoto (JP)

(72) Inventor: Shinya HAYASHIGUCHI, Kyoto-shi, Kyoto (JP)

(73) Assignee: TOWA CORPORATION, Kyoto-shi, Kyoto (JP)

(21) Appl. No.: 19/168,971

(22) PCT Filed: Feb. 27, 2024
(86) PCT No.: PCT/JP2024/007116

§ 371 Date: Sep. 25, 2025

(30) Foreign Application Priority Data
Mar. 27, 2023 (JP) 2023-050045

(51) Int. Cl. B08B 15/00; B08B 13/00; B29C 43/34; H02P 25/18

(52) U.S. Cl. CPC B08B 15/002; B08B 13/00; H02P 25/186; B29C 43/34

(57) ABSTRACT

The present invention is to reduce a power consumption amount of a dust collection apparatus used in a resin molding apparatus, and is a dust collection apparatus that collects dust from one or a plurality of dust collection ports provided in a resin molding apparatus, including an air blower driven by a motor, and an inverter that controls a rotation speed of the motor. The inverter controls the rotation speed of the motor to a first rotation speed, and in a case of lowering the rotation speed from the first rotation speed, the inverter releases an electrical connection to the motor and makes the motor to rotate by inertia.

### TECHNICAL FIELD

The present invention relates to a dust collection apparatus, a resin molding apparatus, and a resin molded product manufacturing method.

### BACKGROUND ART

Conventionally, as disclosed in Patent Literature 1, dust generated in a resin sealing apparatus is collected by a dust collection apparatus. The resin sealing apparatus includes a cleaner portion that cleans an outer frame jig or an inner frame jig that conveys a sheet film and resin. The cleaner portion is provided with a cleaning brush, an air blow, a dust collection mechanism, and the like that are rotationally driven by a drive source to remove resin dust and the like adhering to the outer frame jig or the inner frame jig.

### Citation List

### Patent Literature

Patent Literature 1: JP 2022-61238 A

### SUMMARY OF INVENTION

### Technical Problem

By the way, the proportion of a power consumption amount of the dust collection apparatus in a power consumption amount of the resin molding apparatus is not small.

However, an air blower of the dust collection apparatus in the conventional resin molding apparatus is operated at a constant rotation speed regardless of a dust collection site, a dust collection timing, or the like.

Therefore, the present invention has been made to solve the above problem, and a main object thereof is to reduce the power consumption amount of the dust collection apparatus used in the resin molding apparatus.

### Solution to Problem

That is, a dust collection apparatus according to the present invention is a dust collection apparatus that collects dust from one or a plurality of dust collection ports provided in a resin molding apparatus, including: an air blower driven by a motor; and an inverter that controls a rotation speed of the motor, in which the inverter controls the rotation speed of the motor to a first rotation speed, and in a case of lowering the rotation speed from the first rotation speed, the inverter releases an electrical connection to the motor and makes the motor to rotate by inertia.

### Advantageous Effects of Invention

According to the present invention configured as described above, it is possible to reduce the power consumption amount of the dust collection apparatus used in the resin molding apparatus.

### BRIEF DESCRIPTION OF DRAWINGS

FIG. 1 is a plan view schematically illustrating a configuration of a resin molding apparatus according to an embodiment of the present invention.

FIG. 2 is a schematic diagram illustrating a configuration of a dust collection apparatus according to the embodiment.

FIG. 3 is a schematic diagram indicating control contents of a motor of an air blower in the embodiment.

FIG. 4 is a schematic diagram indicating a motor rotation speed and a power consumption amount in each mode.

### DESCRIPTION OF EMBODIMENTS

Next, technologies according to the present invention will be described in more detail with reference to examples. However, the present invention is not limited by the following technologies.

A dust collection apparatus of technology 1 according to the present invention is a dust collection apparatus that collects dust from one or a plurality of dust collection ports provided in a resin molding apparatus, including: an air blower driven by a motor; and an inverter that controls a rotation speed of the motor, in which the inverter controls the rotation speed of the motor to a first rotation speed, and in a case of lowering the rotation speed from the first rotation speed, the inverter releases an electrical connection to the motor and makes the motor to rotate by inertia.

With this dust collection apparatus, since the electrical connection to the motor is released and the motor is made to rotate by inertia in a case where the rotation speed is lowered from the first rotation speed, it is possible to reduce a power consumption amount of the dust collection apparatus used in the resin molding apparatus. In addition, it is not necessary to perform deceleration control in the case where the rotation speed is lowered from the first rotation speed by the inverter, and it is possible to reduce or eliminate the processing of the regenerative energy generated in the deceleration control. As a result, it is possible to reduce the size of components such as resistors for absorbing the regenerative energy or to make the components unnecessary.

In the dust collection apparatus of technology 2 according to the present invention, in addition to the configuration of technology 1 described above, it is desirable that the inverter switch the rotation speed of the motor between the first rotation speed and a second rotation speed lower than the first rotation speed, and in a case of switching the first rotation speed to the second rotation speed, the inverter release an electrical connection to the motor and make the motor to rotate by inertia.

With this configuration, it is possible to rotate the motor at the first rotation speed in a case where high dust collection performance is required, and to rotate the motor at the second rotation speed in a case where high dust collection performance is not required. As a result, it is possible to appropriately collect dust according to the dust collection site, the dust collection timing, or the like, and it is possible to reduce the power consumption amount of the dust collection apparatus. In addition, since the electrical connection to the motor is released and the motor is made to rotate by inertia in a case where the rotation speed is switched from the first rotation speed to the second rotation speed, it is possible to reduce the power consumption amount at the time of switching to the second rotation speed.

In the dust collection apparatus of technology 3 according to the present invention, in addition to the configuration of technology 2 described above, it is desirable that the inverter control the motor to the second rotation speed after the rotation speed of the motor reaches the second rotation speed by inertial rotation.

With this configuration, it is not necessary to perform the deceleration control from the first rotation speed to the second rotation speed by the inverter, and it is possible to reduce or eliminate the processing of the regenerative energy generated in the deceleration control. As a result, it is possible to reduce the size of components such as resistors for absorbing the regenerative energy or to make the components unnecessary.

In the dust collection apparatus of technology 4 according to the present invention, in addition to any one of the configurations of technologies 1 to 3 described above, it is desirable that dust be collected from a dust collection port provided in a resin material supply module of the resin molding apparatus.

With this configuration, it is possible to collect dust of the resin material supply module in which dust is likely to be generated in the resin molding apparatus, and to make the effect of the present invention more remarkable.

In the dust collection apparatus of technology 5 according to the present invention, in addition to the configuration of technology 4 described above, it is desirable that the inverter switch between a first dust collection state in which dust is collected from a dust collection port provided in the resin material supply module by controlling the motor to the first rotation speed and a second dust collection state in which dust is collected from the dust collection port provided in the resin material supply module by controlling the motor to the second rotation speed.

With this configuration, in the resin material supply module in which dust is likely to be generated in the resin molding apparatus, it is possible to appropriately collect dust according to a dust collection site, a dust collection timing, or the like, and to reduce the power consumption amount of the dust collection apparatus.

In the dust collection apparatus of technology 6 according to the present invention, in addition to the configuration of technology 4 or 5 described above, it is desirable that the resin material supply module include a cleaning stage unit that cleans a conveyance member for conveying a resin material or a release film, and the inverter control the motor to the first rotation speed when the cleaning stage unit cleans the conveyance member.

A large amount of dust is generated when the conveyance member is cleaned. Since the inverter controls the motor to the first rotation speed at the time of cleaning the conveyance member, it is possible to exhibit high dust collection performance, and to efficiently collect dust.

In the dust collection apparatus of technology 7 according to the present invention, in addition to any one of the configurations of technologies 4 to 6 described above, it is desirable that the resin material supply module include a moving stage unit that moves the conveyance member and a stage cleaning unit that cleans the moving stage unit, and the inverter control the motor to the first rotation speed when the stage cleaning unit cleans the moving stage unit.

A large amount of dust is generated when the moving stage unit is cleaned. Since the inverter controls the motor to the first rotation speed at the time of cleaning the moving stage unit, it is possible to exhibit high dust collection performance, and to efficiently collect dust.

In the dust collection apparatus of technology 8 according to the present invention, in addition to any one of the configurations of technologies 4 to 7 described above, it is desirable that the resin material supply module further include a resin material supply unit that supplies the resin material to the conveyance member, and the inverter make the motor to rotate by inertia or control the motor to a second rotation speed lower than the first rotation speed when the resin material supply unit supplies the resin material to the conveyance member.

Dust is less likely to be generated or less dust is generated when the resin material is supplied to the conveyance member. Since the inverter makes the motor to rotate by inertia or controls the rotation speed of the motor to the second rotation speed when the resin material is supplied, it is possible to reduce the power consumption amount of the dust collection apparatus.

In the dust collection apparatus of technology 9 according to the present invention, in addition to any one of the configurations of technologies 4 to 8 described above, it is desirable that the resin material supply module further include a discard unit to which the resin material or a used release film is discarded, and the inverter make the motor to rotate by inertia or control the motor to the second rotation speed when the resin material or the used release film is discarded to the discard unit.

Dust is less likely to be generated or less dust is generated when the resin material or the used release film is discarded to the discard unit. Since the inverter makes the motor to rotate by inertia or controls the rotation speed of the motor to the second rotation speed when the resin material or the used release film is discarded, it is possible to reduce the power consumption amount of the dust collection apparatus.

In the dust collection apparatus of technology 10 according to the present invention, in addition to any one of the configurations of technologies 1 to 9 described above, it is desirable that the dust collection apparatus include: connection piping that connects a plurality of the dust collection ports and the air blower; and a switching mechanism that is provided in the connection piping and switches the dust collection port where dust is collected by the air blower.

With this configuration, it is possible to use a common air blower for the plurality of dust collection ports, and to reduce the number of air blowers. As a result, it is possible to reduce the power consumption amount of the dust collection apparatus.

In the dust collection apparatus of technology 11 according to the present invention, it is desirable that the rotation speed of the motor be set corresponding to the dust collection port switched by the switching mechanism.

With this configuration, for example, in a case of switching to the dust collection port of the cleaning stage unit, the dust collection port of the stage cleaning unit, or the like, it is possible to control the motor to the first rotation speed. In addition, in a case of switching to the dust collection port of other units, it is possible to make the motor rotate by inertia or to control the rotation speed of the motor to the second rotation speed. Note that, in addition to the first rotation speed and the second rotation speed, another rotation speed such as the third rotation speed may be set.

In the dust collection apparatus of technology 12 according to the present invention, in addition to any one of the configurations of technologies 1 to 11 described above, it is desirable that, in a case where the motor is controlled to the first rotation speed from an inertial rotation state, the inverter detect the rotation speed of the motor and resume energization to the motor based on the detected rotation speed.

With this configuration, since the inverter detects the rotation speed of the motor that is rotating by inertia, it is not necessary to separately provide a rotation sensor, and it is possible to simplify the configuration of the dust collection apparatus. Here, it is conceivable that the inverter has a current-detection-type speed search function.

In the dust collection apparatus of technology 13 according to the present invention, in addition to any one of the configurations of technologies 1 to 12 described above, it is desirable that the resin molding apparatus compress and mold the resin material on an object to be molded by a pair of molding dies.

In addition, a resin molding apparatus of technology 14 according to the present invention includes: a resin molding module including a pair of molding dies; a resin material supply module that supplies a resin material to the resin molding module; and the dust collection apparatus according to any one of technologies 1 to 13 described above.

With this resin molding apparatus, since the power consumption amount of the dust collection apparatus can be reduced, it is possible to reduce the power consumption amount of the resin molding apparatus. In addition, since dust can be appropriately collected according to the dust collection site, the dust collection timing, or the like, it is possible to improve the quality of the resin molded product.

Furthermore, a resin molded product manufacturing method of technology 15 according to the present invention is a resin molded product manufacturing method using the resin molding apparatus according to technology 14 described above, including: supplying an object to be molded and a resin material to the molding dies; performing resin molding on the object to be molded; and unloading, from the molding dies, a resin molded product subjected to resin molding.

With this resin molded product manufacturing method, since the power consumption amount of the dust collection apparatus can be reduced, it is possible to reduce the manufacturing cost of the resin molded product. In addition, since dust can be appropriately collected according to the dust collection site, the dust collection timing, or the like, it is possible to improve the quality of the resin molded product.

### Embodiment of Present Invention

Hereinafter, an embodiment of a resin molding apparatus according to the present invention will be described with reference to the drawings. Note that any of the drawings illustrated below is schematically omitted or exaggerated as appropriate for easy understanding. The same components are denoted by the same reference numerals, and the description thereof will be omitted as appropriate.

### 1. Basic Configuration of Resin Molding Apparatus 100

A resin molding apparatus 100 of the present embodiment manufactures a resin molded product P by resin-sealing an electronic component (not illustrated) fixed to a substrate W, which is an object to be molded, by resin molding using a thermosetting resin material J.

Here, examples of the substrate W include a metal substrate, a resin substrate, a glass substrate, a ceramic substrate, a circuit substrate, a semiconductor substrate, a lead frame, a silicon wafer, and a glass wafer. In addition, examples of the electronic component include an electronic element such as a semiconductor chip, a resistance element, or a capacitor element, or an electronic component in which at least one of these electronic elements is resin-sealed. Furthermore, examples of the resin material J include a liquid resin, a sheet-like resin, a tablet-like resin, and a particulate resin (including a granular resin). Note that the resin material J may be a thermoplastic material.

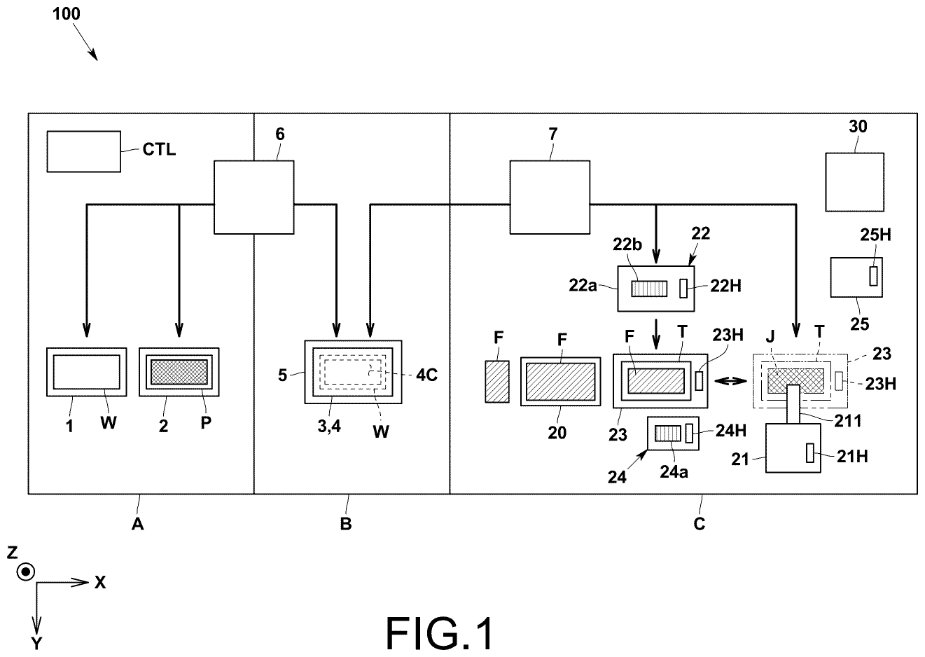

As illustrated in FIG. 1, the resin molding apparatus 100 includes a substrate supply/storage module A, a resin molding module B, and a resin material supply module C as components. Each component (each of the modules A to C) is detachable and replaceable with the other components.

The substrate supply/storage module A includes a pre-molding substrate supply unit 1 that supplies a pre-molding substrate W, and a molded substrate storage unit 2 that stores a molded substrate W (resin molded product P).

The resin molding module B compresses and molds the resin material J on the substrate W. The resin molding module B includes an upper molding die 3 which is a molding die for holding the substrate W, a lower molding die 4 which is a molding die in which a cavity 4C is formed, and a mold clamping mechanism 5 for clamping the upper molding die 3 and the lower molding die 4. The resin molding module B clamps the upper molding die 3 and the lower molding die 4 to resin-seal the electronic component fixed to the substrate W by resin molding using the resin material J.

Here, the substrate supply/storage module A and the resin molding module B are provided with a substrate conveying mechanism 6 that conveys the pre-molding substrate W and the resin molded product P.

The substrate conveying mechanism 6 moves on a rail (not illustrated) extending over the substrate supply/storage module A and the resin molding module B. The substrate conveying mechanism 6 is movable in at least an X direction and a Y direction in the substrate supply/storage module A and the resin molding module B.

In addition, the substrate conveying mechanism 6 conveys the pre-molding substrate W from the substrate supply/storage module A to the resin molding module B, and supplies the pre-molding substrate W to the molding dies 3 and 4 in the resin molding module B. After the resin molding of the pre-molding substrate W, the substrate conveying mechanism 6 receives the resin molded product P from the molding dies 3 and 4 in the resin molding module B and conveys the resin molded product P to the substrate supply/storage module A.

The resin material supply module C uses, for example, a tray T as a conveyance member, and includes a resin material supply unit 21 that supplies, for example, a particulate resin to the tray T. The resin material supply unit 21 includes, at a tip portion, a resin discharge unit 211 that discharges the particulate resin. Note that the resin material supply module C may supply the resin material J in another form such as a liquid resin, a sheet-shaped resin, or a tablet-shaped resin in addition to the particulate resin (including a granular resin).

The tray T of the present embodiment may also include a film holding frame that holds a release film F. Therefore, the resin material supply module C of the present embodiment includes a film cutting unit 20 that cuts the release film F, and the cut release film F is held on the tray T. Note that other configurations of the resin material supply module C will be described later.

Here, the resin material supply module C and the resin molding module B are provided with a resin material conveying mechanism 7 that conveys the tray T.

The resin material conveying mechanism 7 moves on a rail (not illustrated) extending over the resin material supply module C and the resin molding module B.

The resin material conveying mechanism 7 is movable in at least the X direction and the Y direction in the resin material supply module C and the resin molding module B.

In addition, the resin material conveying mechanism 7 conveys the tray T, to which the resin material J is supplied in the resin material supply module C and which holds the release film F, from the resin material supply module C to the resin molding module B. Then, the resin material conveying mechanism 7 supplies the release film F and the resin material J to the molding dies 3 and 4 in the resin molding module B.

After the resin molding of the pre-molding substrate W, the resin material conveying mechanism 7 collects the used release films F from the molding dies 3 and 4 in the resin molding module B. The resin material conveying mechanism 7 can also discard the used release film F to a discard unit 25 in the resin material supply module C.

### 2. Specific Configurations of Resin Material Supply Module C and Dust Collection Apparatus 30

Next, specific configurations of the resin material supply module C and a dust collection apparatus 30 in the present embodiment will be described below.

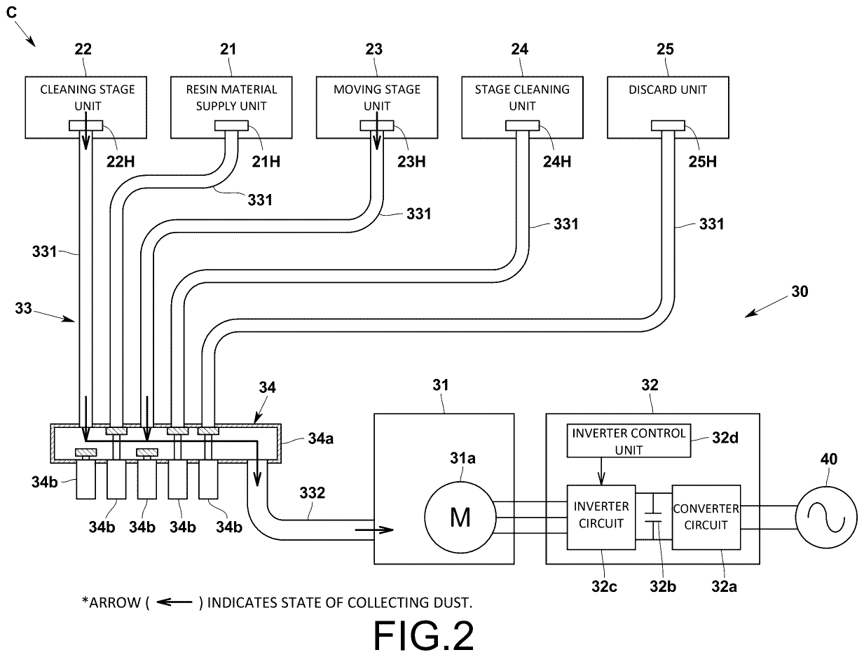

As illustrated in FIGS. 1 and 2, the resin material supply module C of the present embodiment includes, in addition to the above-described configuration, a cleaning stage unit 22 that cleans the tray T, a moving stage unit 23 that moves the tray T or the release film F, a stage cleaning unit 24 that cleans the moving stage unit 23, and the discard unit 25 to which the resin material J or the used release film F is discarded.

As illustrated in FIG. 1, the cleaning stage unit 22 includes a stage 22a on which the tray T is placed, a tray cleaning body 22b such as a brush for cleaning the tray T, and a dust collection port 22H for collecting dust generated by cleaning performed by the tray cleaning body 22b. The dust collection apparatus 30 is connected to the dust collection port 22H (see FIG. 2).

As illustrated in FIGS. 1 and 2, the moving stage unit 23 is an XY stage that moves the tray T or the release film F, and includes a dust collection port 23H for collecting dust generated by cleaning performed by the stage cleaning unit 24. The dust collection apparatus 30 is connected to the dust collection port 23H (see FIG. 2).

In addition, as illustrated in FIG. 1, the stage cleaning unit 24 includes a stage cleaning body 24a such as a brush for cleaning the moving stage unit 23, and may include a dust collection port 24H for collecting dust generated by cleaning performed by the stage cleaning body 24a. The dust collection apparatus 30 is connected to the dust collection port 24H (see FIG. 2). Note that the stage cleaning unit 24 may collect dust on the moving stage unit 23 through the dust collection port 24H without including the stage cleaning body 24a.

As illustrated in FIG. 1, the discard unit 25 is a discard box to which the resin material J or the used release film F is discarded, and includes a dust collection port 25H for collecting dust. The dust collection apparatus 30 is connected to the dust collection port 25H (see FIG. 2).

In addition, the above-described resin material supply unit 21 is also provided with a dust collection port 21H for collecting dust (See FIGS. 1 and 2). The dust collection apparatus 30 is connected to the dust collection port 21H (see FIG. 2).

Note that, in addition to the configuration in which the dust collection ports 21H to 25H are provided in the units 21 to 25, respectively, the dust collection ports 21H to 25H may be provided in the periphery of the units 21 to 25, respectively, corresponding to the respective units 21 to 25.

As illustrated in FIGS. 1 and 2, the dust collection apparatus 30 collects dust from one or a plurality of dust collection ports 21H to 25H provided in the resin material supply module C. The dust collection apparatus 30 of the present embodiment is provided in the resin material supply module C, but may be provided in another module or outside.

Specifically, as illustrated in FIG. 2, the dust collection apparatus 30 includes an air blower 31 driven by a motor 31a and an inverter 32 that controls the rotation speed of the motor 31a.

The air blower 31 includes a blade (not illustrated) and the motor 31a that rotationally drives the blade. The air blower 31 of the present embodiment is a concept including a fan, a blower, or a compressor. In addition, the motor 31a is, for example, a three-phase induction motor.

The inverter 32 controls the rotation speed of the motor 31a by controlling the frequency of an AC voltage output to the motor 31a.

Specifically, the inverter 32 includes a converter circuit 32a that converts the AC voltage of an AC power supply 40 into a DC voltage, a capacitor 32b that smooths the DC voltage from the converter circuit 32a, an inverter circuit 32c that converts the DC voltage smoothed by the capacitor 32b into an AC voltage, and an inverter control unit 32d that controls the inverter circuit 32c. Note that the inverter control unit 32d controls the inverter circuit 32c based on a control command from a control device CTL to be described later.

The inverter circuit 32c of the present embodiment converts the DC voltage into a three-phase AC voltage, and includes a plurality of switching elements (not illustrated). In addition, the inverter control unit 32d controls the plurality of switching elements of the inverter circuit 32c so that an AC voltage of a predetermined frequency is output to the motor 31a.

As illustrated in FIG. 2, the air blower 31 is connected to connection piping 33 connected to the plurality of dust collection ports 21H to 25H. The connection piping 33 is provided with a switching mechanism 34 that switches the dust collection ports 21H to 25H where dust is collected by the air blower 31. That is, to the switching mechanism 34, a plurality of branch pipe portions 331 connected to the respective one of the plurality of dust collection ports 21H to 25H is connected, and a common joining pipe portion 332 connected to the air blower 31 is connected. The switching mechanism 34 switches the dust collection ports 21H to 25H where dust is collected by the air blower 31 by switching the plurality of branch pipe portions 331 communicating with the joining pipe portion 332.

Specifically, the switching mechanism 34 includes a chamber 34a to which the plurality of branch pipe portions 331 is connected, and open/close valves 34b provided in the chamber 34a and open and close the plurality of branch pipe portions 331, such as an electromagnetic valve. In addition, the joining pipe portion 332 is connected to the chamber 34a.

The rotation speed of the motor 31a is set corresponding to the plurality of dust collection ports 21H to 25H switched by the switching mechanism 34. In the present embodiment, either a first rotation speed R_{H} or a second rotation speed R_{L} which is a rotation speed lower than the first rotation speed R_{H} is set corresponding to the plurality of dust collection ports 21H to 25H.

Here, the first rotation speed R_{H} is a rotation speed for collecting dust with high dust collection performance (strong dust collection mode), and is, for example, 90 rpm to 120 rpm. In addition, the second rotation speed R_{L} is a rotation speed for collecting dust with normal dust collection performance (medium dust collection mode), and is, for example, 50 rpm to 60 rpm.

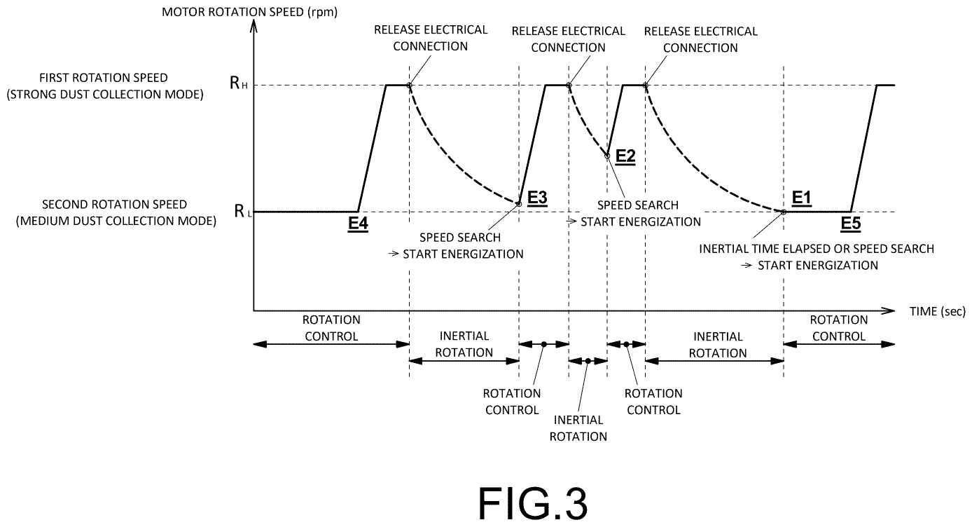

As illustrated in FIG. 3, the inverter 32 controls the rotation speed of the motor 31a to the first rotation speed R_{H}, and in a case of lowering the rotation speed from the first rotation speed R_{H}, the inverter 32 releases the electrical connection to the motor 31a and makes the motor 31a to rotate by inertia. Here, inertial rotation is a state in which the motor 31a rotates by inertia when the power supply from the inverter 32 is cut off while the motor 31a is rotating, and is also called free run or idling.

Specifically, as illustrated in FIG. 3, the inverter 32 switches the rotation speed of the motor 31a between the first rotation speed R_{H} and the second rotation speed R_{L}. In addition, in a case of switching the first rotation speed R_{H} to the second rotation speed R_{L}, the inverter 32 releases the electrical connection to the motor 31a and makes the motor 31a rotate by inertia. Then, after the motor 31a reaches the second rotation speed R_{L} by the inertial rotation, the inverter 32 controls the motor 31a to the second rotation speed R_{L}.

Furthermore, the inverter 32 switches between a first dust collection state (strong dust collection mode) in which dust is collected from the dust collection ports 21H to 25H provided in the resin material supply module C by controlling the motor 31a to the first rotation speed R_{H} and a second dust collection state (medium dust collection mode) in which dust is collected from the dust collection ports 21H to 25H provided in the resin material supply module C by controlling the motor 31a to the second rotation speed R_{L}.

Specifically, the inverter 32 controls the motor 31a to the first rotation speed R_{H} when the tray T is cleaned by the cleaning stage unit 22 or when the moving stage unit 23 is cleaned by the stage cleaning unit 24. As a result, it becomes in the first dust collection state (strong dust collection mode) in which dust is collected from the dust collection port 22H of the cleaning stage unit 22, the dust collection port 23H of the moving stage unit 23, or the dust collection port 24H of the stage cleaning unit 24.

Meanwhile, the inverter 32 makes the motor 31a to rotate by inertia or controls the motor 31a to the second rotation speed R_{L} after making the motor 31a to rotate by inertia when the resin material is supplied to the tray T by the resin material supply unit 21 or when the resin material J or the used release film F is discarded to the discard unit 25. As a result, it becomes in the second dust collection state (medium dust collection mode) in which dust is collected from the dust collection port 21H of the resin material supply unit 21 or the dust collection port 25H of the discard unit 25. In addition, the inverter 32 constantly controls the motor 31a to the second rotation speed R_{L} except when the tray T is cleaned by the cleaning stage unit 22 and when the moving stage unit 23 is cleaned by the stage cleaning unit 24.

### 3-1. Control to Second Rotation Speed R_{L} From Inertial Rotation

Here, a case where the motor 31a is controlled to the second rotation speed R_{L} from the inertial rotation state will be described.

In a case where the motor 31a is controlled to the second rotation speed R_{L} from the inertial rotation state, it is conceivable that, after a predetermined inertial time elapses from when the electrical connection to the motor 31a controlled to the first rotation speed R_{H} is released, the inverter 32 resume the energization to the motor 31a and control to the second rotation speed R_{L}, as indicated at a time point “E1” in FIG. 3. Here, the predetermined inertial time can be set, by calculation or experiment in advance, by obtaining a time until the motor 31a rotates by inertia and decelerates to the second rotation speed R_{L} after the electrical connection to the motor 31a rotating at the first rotation speed R_{H} is released.

In addition, in a case where the motor 31a is controlled to the second rotation speed R_{L} from the inertial rotation state, after a predetermined time elapses from when the electrical connection to the motor 31a controlled to the first rotation speed R_{H} is released, the inverter 32 detects the rotation speed of the motor 31a rotating by inertia by using a speed search function, as indicated at the time point “E1” in FIG. 3. It is conceivable that the inverter 32 resume the energization to the motor 31a based on the detected rotation speed and control to the second rotation speed R_{L}.

Note that the speed search function of the inverter 32 is a current-detection-type speed search function incorporated in the inverter 32, and is performed before the energization to the motor 31a is resumed. This current-detection-type speed search function is known in which, while sweeping the frequency of the AC voltage supplied to the motor 31a, the current flowing through the motor 31a at that time is detected, and the rotation speed of the motor 31a is identified (estimated) based on the detected current.

### 3-2. Control to First Rotation Speed R_{H} From Inertial Rotation

Next, a case where the motor 31a is controlled to the first rotation speed R_{H} from the inertial rotation state will be described.

In a case where the motor 31a is controlled to the first rotation speed R_{H} from the inertial rotation state, the inverter 32 detects the rotation speed of the motor 31a, and resumes the energization to the motor 31a based on the detected rotation speed, as indicated by time points “E2” and “E3” in FIG. 3.

Specifically, when receiving a control command to the first rotation speed R_{H} while the motor 31a is in the inertial rotation state, the inverter 32 detects the rotation speed of the motor 31a that is rotating by inertia by using the speed search function described above. The inverter 32 resumes the energization to the motor 31a based on the detected rotation speed, and controls the motor 31a to the first rotation speed R_{H}.

3-3. Control to First Rotation Speed R_{H} From Second Rotation Speed R_{L}

Note that, in a case of receiving the control command to the first rotation speed R_{H} while controlling the motor 31a to the second rotation speed R_{L}, the inverter 32 gradually increases the rotation speed of the motor 31a without using the current-detection-type speed search function, and controls to the first rotation speed R_{H}, as indicated at time points “E4” and “E5” in FIG. 3.

### 4. Rotation Speed and Power Consumption Amount in Each Mode

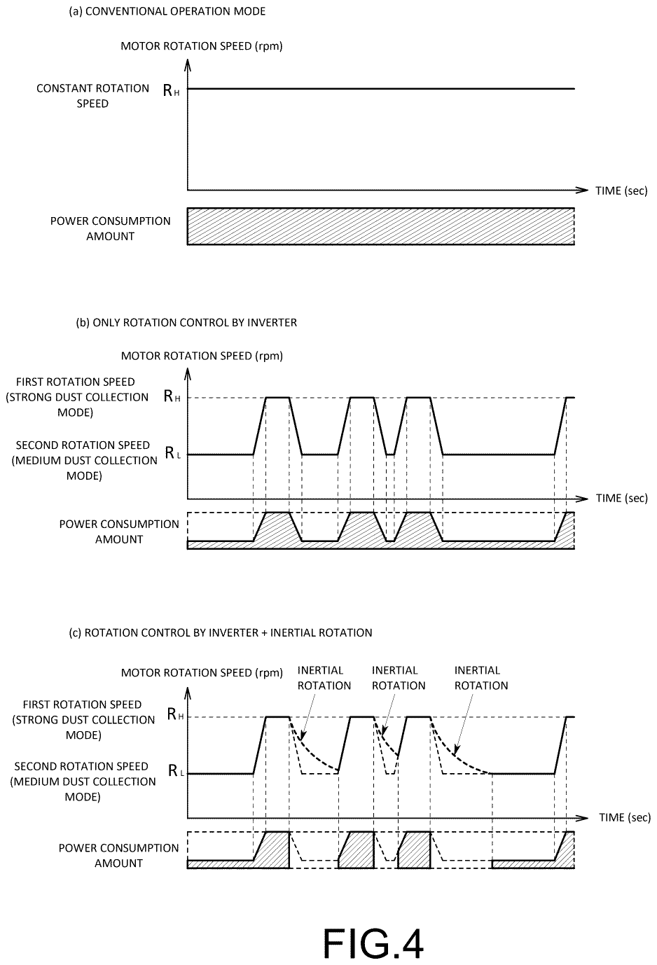

Next, the rotation speed and the power consumption amount in three operation modes will be described with reference to FIG. 4.

Here, the first operation mode (see FIG. 4(a)) is a conventional operation mode in which the motor 31a of the air blower 31 is controlled to have a constant rotation speed (first rotation speed R_{H}). In the second operation mode (see FIG. 4(b)), the rotation control of the motor 31a of the air blower 31 is performed by the inverter 32, and the motor 31a of the air blower is subjected to acceleration control and deceleration control between the first rotation speed R_{H} (strong dust collection mode) and the second rotation speed R_{L} (medium dust collection mode). The third operation mode (see FIG. 4(c)) is an operation mode of the present embodiment, in which the rotation control of the motor 31a of the air blower 31 is performed by the inverter 32, and the motor 31a of the air blower 31 is made to rotate by inertia when being switched from the first rotation speed R_{H} (strong dust collection mode) to the second rotation speed R_{L} (medium dust collection mode).

In the first operation mode, constant power is consumed regardless of a dust collection position. In the second operation mode, the power consumption amount of the dust collection apparatus 30 can be reduced as compared with the first operation mode. This leads to a reduction in power consumption amount of the resin molding apparatus 100. Furthermore, in the third operation mode, the power consumption amount at the time of deceleration can be further reduced as compared with the second operation mode, and components such as a resistor for consuming regenerative energy at the time of deceleration can be reduced in size or made unnecessary.

### 5. Resin Molding Operation of Resin Molding Apparatus 100

Next, an example of the operation of the resin molding apparatus 100 will be described with reference to FIG. 1. The following operation is performed, for example, by the control device CTL provided in the substrate supply/storage module A controlling each unit of the resin molding apparatus 100. Note that the control device CTL is a dedicated or general-purpose computer including a CPU, an internal memory, an input/output interface, an AD converter, and the like.

### (1) Pre-Molding Substrate Supply Step

In the substrate supply/storage module A, the substrate conveying mechanism 6 receives the pre-molding substrate W from the pre-molding substrate supply unit 1 and conveys the pre-molding substrate W to the resin molding module B. Then, the pre-molding substrate W is transferred to the opened upper molding die 3. Thereafter, the substrate conveying mechanism 6 returns to a predetermined standby position.

### (2) Resin Material Supply Step

In the resin material supply module C, the resin material supply unit 21 supplies the resin material J onto the release film F held on the tray T. At this time, the inverter 32 controls the motor 31a to the second rotation speed R_{L} to set the mode to the medium dust collection mode. In addition, the switching mechanism 34 performs switching such that dust is collected from the dust collection port 21H of the resin material supply unit 21.

Thereafter, the resin material conveying mechanism 7 conveys the tray T to the resin molding module B, and supplies the resin material J together with the release film F to the cavity 4C of the opened lower molding die 4. Then, the resin material conveying mechanism 7 returns to a predetermined standby position.

Here, the resin material conveying mechanism 7 conveys the tray T that has supplied the resin material J to the cleaning stage unit 22, and the tray T is cleaned by the cleaning stage unit 22. At this time, the inverter 32 controls the motor 31a to the first rotation speed R_{H} to set the mode to the strong dust collection mode. In addition, the switching mechanism 34 performs switching such that dust is collected from the dust collection port 22H of the cleaning stage unit 22. The dust collection by the dust collection port 22H is started before or simultaneously with the start of the cleaning by the cleaning stage unit 22. In addition, when the cleaning by the cleaning stage unit 22 is completed, the inverter 32 releases the electrical connection to the motor 31a and makes the motor 31a to rotate by inertia and shift to the medium dust collection mode.

In addition, the moving stage unit 23 is cleaned by the stage cleaning unit 24 after the tray T or the release film F is moved. At this time, the inverter 32 controls the motor 31a to the first rotation speed R_{H} to set the mode to the strong dust collection mode. In addition, the switching mechanism 34 performs switching such that dust is collected from the dust collection port 23H of the moving stage unit 23 or the dust collection port 24H of the stage cleaning unit 24. Note that the dust collection by the dust collection port 23H or the dust collection port 24H is started before or simultaneously with the start of the cleaning by the stage cleaning unit 24. In addition, when the cleaning by the stage cleaning unit 24 is completed, the inverter 32 releases the electrical connection to the motor 31a and makes the motor 31a to rotate by inertia and shift to the medium dust collection mode.

### (3) Resin Molding Step

After the step described above, in the resin molding module B, the upper molding die 3 and the lower molding die 4 are clamped by the mold clamping mechanism 5 with a predetermined clamping pressure and are heated. After a predetermined time elapses, the lower molding die 4 is lowered by the mold clamping mechanism 5, and the upper molding die 3 and the lower molding die 4 are opened.

### (4) Molded Substrate Unloading Step

In a molded substrate unloading step, the substrate conveying mechanism 6 is moved to receive the resin molded product P from the opened upper molding die 3. Then, the substrate conveying mechanism 6 that has received the resin molded product P is moved to the substrate supply/storage module A, and the resin molded product P is transferred from the substrate conveying mechanism 6 to the molded substrate storage unit 2 and stored in the molded substrate storage unit 2.

### (5) Used Release Film Collecting Step

In a used release film collecting step, the resin material conveying mechanism 7 is moved to collect the used release film F from the opened lower molding die 4. Then, the resin material conveying mechanism 7 that has collected the used release film F is moved to the resin material supply module C, and the used release film F is discarded to the discard unit 25. At this time, the inverter 32 controls the motor 31a to the second rotation speed R_{L} to set the mode to the medium dust collection mode. In addition, the switching mechanism 34 performs switching such that dust is collected from the dust collection port 25H of the discard unit 25.

### 6. Effects of Present Embodiment

According to the resin molding apparatus 100 of the present embodiment, since the rotation speed of the motor 31a is controlled to the first rotation speed R_{H}, and the electrical connection to the motor 31a is released and the motor 31a is made to rotate by inertia in a case where the rotation speed is lowered from the first rotation speed R_{H}, it is possible to reduce the power consumption amount of the dust collection apparatus 30 used in the resin molding apparatus 100. It is possible to rotate the motor 31a at the first rotation speed R_{H} in a case where high dust collection performance is required, and to rotate the motor 31a at the second rotation speed R_{L} in a case where high dust collection performance is not required. As a result, it is possible to appropriately collect dust according to the dust collection site, the dust collection timing, or the like, and it is possible to reduce the power consumption amount. In addition, since dust can be appropriately collected according to the dust collection site, the dust collection timing, or the like, it is possible to improve the quality of the resin molded product P.

### 7. Other Modifications

Note that the present invention is not limited to the above embodiment.

For example, the dust collection apparatus 30 may collect dust of other modules (for example, the resin molding module B) in addition to or instead of the resin material supply module C. In this case, a dust collection port is provided in the module from which dust is collected, and the dust collection apparatus 30 is connected to the dust collection port.

In the above embodiment, two stages of the first rotation speed R_{H} and the second rotation speed R_{L} have been switched, but there may be three or more stages to be switched by adding other rotation speeds.

As a method of detecting the rotation speed of the motor 31a rotating by inertia, a rotation sensor may be provided in the motor 31a or the like to detect the rotation speed of the motor 31a in addition to the speed search function of the inverter 32.

The tray T of the above embodiment includes the film holding frame to hold the release film F, but the tray T may not hold the release film F. In this case, the tray T has a bottomed storage portion that stores the resin material J.

In addition, the configuration for supplying the resin material J to the cavity 4C may be a configuration for supplying the resin material J to the cavity 4C of the lower molding die 4 by moving the resin material supply unit 21 to the lower molding die 4, or may be a configuration for performing other types of compression molding. Furthermore, the resin molding apparatus 100 may be configured to perform transfer molding in which the resin material J is stored in a pot provided in the lower molding die 4 and the resin material J is pushed out by a plunger.

In the above embodiment, one resin molding module B is connected between the substrate supply/storage module A and the resin material supply module C, but two or more resin molding modules B may be connected. In addition, the substrate supply/storage module A and the resin material supply module C may be configured as one module, and the resin molding module B may be connected to the module.

Moreover, a film cutting module may be separated from the resin material supply module C to be modularized. Furthermore, the resin molding apparatus may not be modularized into each module as in the above embodiment.

In addition, the present invention is not limited to the above embodiment, and it goes without saying that various modifications can be made without departing from the gist of the present invention.

### Industrial Applicability

According to the present invention, the present invention can reduce the power consumption amount of the dust collection apparatus used in the resin molding apparatus.

### Reference Signs List

100 resin molding apparatus
B resin molding module
C resin material supply module
W object to be molded
P resin molded product
F release film
T tray
3,4 molding die
21 resin material supply unit
22 cleaning stage unit
23 moving stage unit
24 stage cleaning unit
25 discard unit
21H to 25H dust collection port
30 dust collection apparatus
31 air blower
31a motor
R_{H} first rotation speed
R_{L} second rotation speed
32 inverter
33 connection piping
34 switching mechanism

1. A dust collection apparatus that collects dust from one or a plurality of dust collection ports provided in a resin molding apparatus, the dust collection apparatus comprising:
an air blower driven by a motor; and
an inverter that controls a rotation speed of the motor, wherein
the inverter controls the rotation speed of the motor to a first rotation speed, and in a case of lowering the rotation speed from the first rotation speed, the inverter releases an electrical connection to the motor and makes the motor to rotate by inertia.

2. The dust collection apparatus according to claim 1, wherein the inverter switches the rotation speed of the motor between the first rotation speed and a second rotation speed lower than the first rotation speed, and in a case of switching the first rotation speed to the second rotation speed, the inverter releases an electrical connection to the motor and makes the motor to rotate by inertia.

3. The dust collection apparatus according to claim 2, wherein the inverter controls the motor to the second rotation speed after the rotation speed of the motor reaches the second rotation speed by inertial rotation.

4. The dust collection apparatus according to claim 1, wherein dust is collected from a dust collection port provided in a resin material supply module of the resin molding apparatus.

5. The dust collection apparatus according to claim 4, wherein the inverter switches between a first dust collection state in which dust is collected from a dust collection port provided in the resin material supply module by controlling the motor to the first rotation speed and a second dust collection state in which dust is collected from the dust collection port provided in the resin material supply module by controlling the motor to the second rotation speed lower than the first rotation speed.

6. The dust collection apparatus according to claim 4, wherein
the resin material supply module includes a cleaning stage unit that cleans a conveyance member for conveying a resin material or a release film, and
the inverter controls the motor to the first rotation speed when the cleaning stage unit cleans the conveyance member.

7. The dust collection apparatus according to claim 6, wherein
the resin material supply module includes a moving stage unit that moves the conveyance member and a stage cleaning unit that cleans the moving stage unit, and
the inverter controls the motor to the first rotation speed when the stage cleaning unit cleans the moving stage unit.

8. The dust collection apparatus according to claim 6, wherein
the resin material supply module further includes a resin material supply unit that supplies the resin material to the conveyance member, and
the inverter makes the motor to rotate by inertia or controls the motor to the second rotation speed when the resin material supply unit supplies the resin material to the tray.

9. The dust collection apparatus according to claim 4, wherein
the resin material supply module further includes a discard unit to which the resin material or a used release film is discarded, and
the inverter makes the motor to rotate by inertia or controls the motor to the second rotation speed when the resin material or the used release film is discarded to the discard unit.

10. The dust collection apparatus according to claim 1, comprising:
connection piping that connects a plurality of the dust collection ports and the air blower; and
a switching mechanism that is provided in the connection piping and switches the dust collection port where dust is collected by the air blower.

11. The dust collection apparatus according to claim 10, wherein the rotation speed of the motor is set corresponding to the dust collection port switched by the switching mechanism.

12. The dust collection apparatus according to claim 1, wherein in a case where the motor is controlled to the first rotation speed from an inertial rotation state, the inverter detects the rotation speed of the motor and resumes energization to the motor based on the detected rotation speed.

13. The dust collection apparatus according to claim 1, wherein the resin molding apparatus compresses and molds the resin material on an object to be molded by a pair of molding dies.

14. A resin molding apparatus comprising:
a resin molding module including a pair of molding dies;
a resin material supply module that supplies a resin material to the resin molding module; and
the dust collection apparatus according to claim 1.

15. A resin molded product manufacturing method using the resin molding apparatus according to claim 14, comprising:
supplying an object to be molded and a resin material to the molding dies;
performing resin molding on the object to be molded; and
unloading, from the molding dies, a resin molded product subjected to resin molding.
